(19) United States
(12) Patent Application Publication
(10) Pub. No.: US 2025/0385544 A1
(43) Pub. Date: Dec. 18, 2025

(54) SYSTEMS AND METHODS FOR GHOST POWER MANAGEMENT

(71) Applicant: EATON INTELLIGENT POWER LIMITED, DUBLIN 4 (IE)

(72) Inventors: Ankur Srivastav, Lucknow (IN); Suchandra Mandal, Galway (IE)

(73) Assignee: EATON INTELLIGENT POWER LIMITED, DUBLIN 4 (IE)

(21) Appl. No.: 19/237,381

(22) Filed: Jun. 13, 2025

Related U.S. Application Data
(60) Provisional application No. 63/659,908, filed on Jun. 14, 2024.

(51) Int. Cl. H02J 13/00; G06Q 50/06

(52) U.S. Cl. CPC H02J 13/00002; G06Q 50/06; H02J 13/00001; H02J 13/00022; H02J 13/00028; H02J 13/00036; H02J 2310/14

(57) ABSTRACT

Systems and methods for power management via smart circuit breaker devices based on ghost power modes are described. In one example, a computer-implemented method may include, monitoring power usage of a device detected by a smart circuit breaker to be electrically coupled to a circuit breaker of the smart circuit breaker, accessing a ghost power profile of the device, the ghost power profile comprising ghost power information including a ghost power threshold indicating that the device is operating in ghost power mode, determining that the device is operating in the ghost power mode based on a comparison of the power usage with the ghost power threshold, and performing a ghost power event responsive to determining that the device is operating in the ghost power mode. A ghost power event may include closing a circuit breaker or calculating ghost power costs.

### CROSS REFERENCE TO RELATED APPLICATION

This application claims priority to U.S. Provisional Patent Application Ser. No. 63/659,908, filed on Jun. 14, 2025 and titled “SYSTEM AND METHOD TO IDENTIFY GHOST POWER USAGE OF APPLIANCES AND OPTIMIZE ENERGY MANAGEMENT,” the entire contents of which are incorporated herein by reference.

### TECHNOLOGICAL FIELD

The disclosed concept relates generally to energy management implemented via smart circuit breakers, and, in particular, to analyzing and managing ghost power usage.

### BACKGROUND

Ghost power (or phantom power or loads) is energy consumed by a device that is plugged into a power supply, but the device is not active for its primary purpose, which may include being powered off, in standby mode, and/or the like. Although the ghost power consumption of devices is typically significantly lower than the power draw when the devices are in active use, estimates indicate that home electronics are in standby or are powered off (yet plugged in) about 75% of the time and that ghost power accounts for as much as 10% of residential energy costs. Energy expenses due to ghost power consumption may be even higher for commercial and manufacturing facilities.

Accordingly, when electronic devices are left plugged into wall outlets when inactive, the devices continue to consume material amounts of energy and contribute to higher electricity bills. It is inconvenient and impractical to unplug many appliances and electronic devices when not in use, such as smart televisions, cable boxes, coffee makers, microwave ovens, dishwashers, device chargers, and/or the like. Although manufacturers provide standby modes, low power modes, and/or the like in an attempt to lower ghost power consumption, such conventional techniques are not able to proactively and comprehensively manage ghost power usage in a manner that materially benefits residential and commercial energy consumers.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

The present disclosure describes various embodiments of a ghost power management system implemented using smart circuit breaker devices.

In one embodiment, a computer-implemented method may include, via at least one processing circuitry operatively coupled to a smart circuit breaker, monitoring power usage of a device detected by the smart circuit breaker to be electrically coupled to a circuit breaker of the smart circuit breaker; accessing a ghost power profile of the device, the ghost power profile comprising ghost power information including a ghost power threshold indicating that the device is operating in ghost power mode; determining that the device is operating in the ghost power mode based on a comparison of the power usage with the ghost power threshold; and performing a ghost power event responsive to determining that the device is operating in the ghost power mode.

In some embodiments of the method, the ghost power event includes closing the circuit breaker.

In various embodiments of the method, the ghost power event includes determining a cost of operating the device in the ghost power mode.

In some embodiments of the method, the method further includes receiving device information of the device via a power management application interface, determining an operating current for the device based on the device information, and determining the ghost power threshold as at least one of a value or percentage below the operating current.

In exemplary embodiments of the method, the device information includes an image and the operating current is determined based on at least one of an automated internet search or a web-crawling process.

In some embodiments of the method, the method further includes determining the ghost power threshold based on an operating current of the device, in which the ghost power threshold includes one of a percentage of the operating current or a value below the operating current.

In various embodiments of the method, the method further includes providing a user interface to graphically designate that the device is operating in the ghost power mode.

In some embodiments of the method, the method further includes determining that the device is not operating in the ghost power mode based on the comparison of the power usage with the ghost power threshold responsive to a current of the device being greater than the ghost power threshold.

In various embodiments of the method, the method further includes determining whether an anomaly is present responsive to the device not operating below the ghost power threshold based on the ghost power profile indicating that the device is expected to be operating in the ghost power mode.

In exemplary embodiments of the method, the method further includes closing the circuit breaker responsive to detecting the anomaly.

In one embodiment, a smart circuit breaker panel may include a plurality of smart circuit breakers; a plurality of sensors configured to monitor power usage of devices electrically coupled to the plurality of smart circuit breakers; and an embedded control unit operably coupled to the plurality of smart circuit breakers. The control unit includes a memory coupled to a processing circuitry, the memory comprising instructions that, when executed by the processing circuitry, cause the at least one processing circuitry to: monitor power usage of the devices measured by the plurality of sensors; access at least one ghost power profile associated with at least one of the devices, the at least one ghost power profile comprising ghost power information including a ghost power threshold indicating that the at least one of the devices is operating in ghost power mode; determine that the device is operating in the ghost power mode based on a comparison of the power usage with the ghost power threshold; and perform a ghost power event responsive to determining that the device is operating in the ghost power mode.

In some embodiments of the smart circuit breaker panel, the ghost power event includes closing the circuit breaker.

In various embodiments of the smart circuit breaker panel, the ghost power event includes determining a cost of operating the device in the ghost power mode.

In some embodiments of the smart circuit breaker panel, the instructions, when executed by the processing circuitry, cause the at least one processing circuitry to: receive device information of the device via a power management application interface; determine an operating current for the device based on the device information; and determine the ghost power threshold as at least one of a value or percentage below the operating current.

In exemplary embodiments of the smart circuit breaker panel, the device information includes an image and the operating current is determined based on at least one of an automated internet search or a web-crawling process.

In some embodiments of the smart circuit breaker panel, the instructions, when executed by the processing circuitry, cause the at least one processing circuitry to determine the ghost power threshold based on an operating current of the device, wherein the ghost power threshold comprises one of a percentage of the operating current or a value below the operating current.

In various embodiments of the smart circuit breaker panel, the instructions, when executed by the processing circuitry, cause the at least one processing circuitry to provide a user interface to graphically designate that the device is operating in the ghost power mode.

In one embodiment, a computer-implemented method may include, via at least one processing circuitry operably coupled to a smart circuit breaker system: accessing device information of at least one device electrically coupled to a circuit breaker of the smart circuit breaker system, the device information comprising at least one of an image, a device identifier, a serial number, or a model number; determine operating current information for the device based on the device information; measure power usage information of the device via at least one sensor operably coupled to the circuit breaker; and determine a ghost power threshold for the device based on the operating current information and the power usage information, the ghost power threshold comprising a current usage value indicating that the device is in a ghost power mode.

In some embodiments of the method, the method may include determining that the device is operating in the ghost power mode based on a comparison of power usage of the device with the ghost power threshold; and performing a ghost power event responsive to determining that the device is operating in the ghost power mode.

In various embodiments of the method, the ghost power event includes closing the circuit breaker responsive to a plurality of devices associated with the circuit breaker operating in the ghost power mode.

In one embodiment, a method for monitoring and managing ghost power usage and phantom power consumption in a system includes a number of smart circuit breakers may include collecting raw data from the number of smart circuit breakers in real time, the raw data including current, voltage, and energy data for all appliances connected as loads to the number of smart circuit breakers; time stamping the raw data and transmitting the raw data to a database, determining the performance specifications of all of the appliances; calculating the operating current for all of the appliances; and calculating ghost power usage, in which calculating the operating current does not require user input and can be achieved via web scraping, and calculating ghost power usage takes into account utility-provided data.

In one embodiment, a power management system may include a main circuit breaker structured to be connected to a power supply, the main circuit breaker includes a controller and being configured to communicate with a data cloud, a number of branch circuit breakers connected to the main circuit breaker, each branch circuit breaker being configured to electrically connect a number of loads to power routed through the main circuit breaker, each branch circuit breaker includes a controller and being configured to communicate with the main circuit breaker and the data cloud, wherein at least one of the main circuit breaker, one of the number of branch circuit breakers, or the data cloud are configured to implement a method for monitoring and managing ghost power usage and phantom power consumption, the method including: collecting raw data from the main circuit breaker and branch circuit breakers in real time, the raw data including current, voltage, and energy data for all appliances connected as loads to the branch circuit breakers; time stamping the raw data and transmitting the raw data to the data cloud, determining the performance specifications of all of the appliances; calculating operating current for all of the appliances; and calculating ghost power usage, wherein calculating operating current does not require user input and can be achieved via web scraping, and wherein calculating ghost power usage takes into account utility-provided data.

In some embodiments of the power management system, at least one of the main circuit breaker or one of the number of branch circuit breakers is configured to enable a user to provide input to the power management system.

In various embodiments of the power management system, at least one of the main circuit breaker, the number of branch circuit breakers, or the data cloud is configured to communicate with a mobile phone or personal computer via an application, wherein the application enables a user to provide input to the power management system.

### BRIEF DESCRIPTION OF THE DRAWINGS

By way of example, features of the disclosed components and systems will now be described, with reference to the accompanying drawings, in which:

FIG. 1 illustrates a first exemplary operating environment in accordance with the present disclosure;

FIG. 2 illustrates a second exemplary operating environment in accordance with the present disclosure;

FIGS. 3A and 3B illustrate a method flow in accordance with the present disclosure;

FIG. 4 illustrates a first logic flow in accordance with the present disclosure; and

FIG. 5 illustrates a second logic flow in accordance with the present disclosure.

### DETAILED DESCRIPTION

Various features of an improved ghost power management system are described in the present disclosure, with reference to the accompanying drawings, in which one or more features of the ghost power management system are shown and described. The various features described in the present disclosure and depicted in the accompanying drawings may be used independently of, or in combination with, each other. A ghost power management system as disclosed herein may be embodied in many different forms and should not be construed as being limited to the examples set forth herein. Rather, these examples are provided to convey certain features of the ghost power management system to those skilled in the art.

A ghost power management system may be configured to analyze, manage, or otherwise process various aspects of ghost power usage of a circuit system, such as a residential or commercial electrical system. Ghost power includes energy consumption by an electrical device when plugged into a power supply, but inactive for its primary purpose. For example, a television may draw ghost power when plugged into an electrical outlet and powered off. In another example, a device charger may draw ghost power when plugged into an electrical outlet, but not connected to a device for charging. Other terms for ghost power may include a ghost load, phantom power, a phantom load, standby mode, standby power, a standby load, low power mode, a low power load, a powered-off load, and/or the like.

The ghost power management system may be implemented via a smart circuit breaker and/or smart panel (or smart circuit breaker panel). In general, a “smart” circuit breaker or smart circuit breaker panel may be a circuit breaker or panel configured to provide one or more programmed, automated, or “smart” features, including, without limitation, energy usage (for instance, current and/or voltage level) monitoring, the ability to cut off an electrical supply under certain programmed conditions, wired and/or wireless communication capabilities, the ability to self-monitor performance and to self-report performance information, voltage and current data storage capabilities. and/or the like. Non-limiting examples of smart circuit breakers and/or smart panels may include smart circuit breakers and/or panels provided by Eaton Corporation PLC of Dublin, Ireland including, without limitation, BREM, BABEM, and/or AbleEdge® devices. In some embodiments, control of a smart circuit breaker or panel and/or access to information generated by a smart circuit breaker and/or panel may be accessible via a user computing device, such as through an application or mobile application (or “app”) operating on a laptop, smartphone, tablet computing device, workstation, PC, and/or other computing device.

The ghost power management system may be configured to perform ghost power management methods operative to, among other things, identify ghost power, calculate costs of ghost power (or phantom) loads, calculate costs of ghost power loads left on for extended periods of time, enable a user to take action to automatically switch on/off circuit breakers with loads identified as consuming ghost power, and identify anomalies in usage of devices for security, safety (for instance, opening circuit breakers, generating alarms, and/or the like), energy cost reduction, and/or the like purposes.

In some embodiments, the ghost power management methods may use power profile data from various loads collected via smart circuit breakers. In various embodiments, the ghost power management methods may operate by combining web-scraping and/or third party utility data to create and/or perform algorithms that can detect ghost power modes of electrical devices and use the knowledge for various applications, including, without limitation, energy consumption of loads from devices in ghost power mode, reducing or even eliminating unwanted ghost power energy consumption and costs associated with ghost power mode usage, detecting anomalies associated with ghost power, automated control of turning on/off the power from ghost power and/or power anomaly devices automatically and/or via user application.

The ghost power management methods according to the present disclosure can be used in residential, commercial, and/or industrial buildings to manage energy consumptions from phantom loads. For example, in one non-limiting technological advantage, ghost power management methods may facilitate a user providing an active feedback role and/or faster or more efficient involvement in informed management of ghost power loads. In one non-limiting technological advantage, ghost power management methods may facilitate combining the determination of ghost power mode with utility costs, providing informed information for energy and cost reduction for the user to implement power management via a smart circuit breaker or panel via automatic turning off devices consuming ghost power and/or demonstrating anomalous electrical conditions. In one non-limiting technological advantage, ghost power management methods may facilitate ghost power information consumption for various association mapping rules that can help to understand which devices are mostly being used or on standby with others (for instance, ghost power groups). Such technical functionality may support flagging/alerting users of anomalous usage and or mimic normal reduced behavior of remote device control when users are away from the environment (for instance, for extended periods of time).

Conventional smart circuit breakers and panels are able to provide software-based and computer-based information and control of circuit breakers. For example, existing smart circuit breakers may be able to provide information on voltage and/or current usage through the circuit breaker. In another example, existing circuit breakers may be able to allow a user to view the status of a circuit breaker and to open/close the circuit breaker remotely (for instance, via a mobile app on a smartphone in wireless communication with the smart circuit breaker).

However, existing smart circuit breakers do not provide accurate, efficient, or useful ghost power information or ghost power-based control of circuit breaker devices. However, ghost power contributes significantly to residential, commercial, and industrial electricity usage and, therefore, costs. Accordingly, although existing smart circuit breakers provide computer-implemented methods for obtaining power consumption information and circuit breaker device control, there remains a major gap in technical functionality because existing smart circuit breakers are not able to adequately or effectively provide ghost power information or ghost power-based control.

For example, with an existing smart circuit breaker, a user may be able to determine the amount of power consumed through the smart circuit breaker. However, the user will not have information regarding what part of that power was due to ghost power, which specific devices contributed to the ghost power, and/or the like. As a result, a user may not be able to take accurate and informed control to reduce or eliminate main sources of ghost power usage (such as turning off a circuit breaker from 10:00 pm until 6:00 am that only consumes ghost power over that time period). In another example, with an existing smart circuit breaker, protection may not be provided responsive to an anomalous power draw by a device operating outside of the ghost power profile of the device. Accordingly, some embodiments provide a ghost power management system and ghost power management methods capable of providing robust, effective, and intelligent ghost power energy consumption information and ghost power-based control of circuit breaker devices.

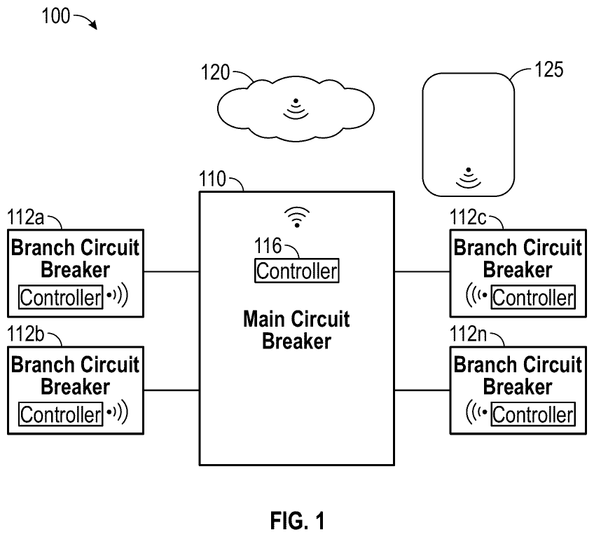

FIG. 1 illustrates a first exemplary operating environment in accordance with the present disclosure. As shown in FIG. 1, an operating environment 100 may be or may include a power management system that includes a main circuit breaker 110 and a number of branch circuit breakers 112a-n connected to the main circuit breaker 110. Each branch breaker 112a-n can be connected to a number of loads. In an exemplary embodiment, all of the circuit breakers 110 and 112a-n are smart circuit breakers that are able to communicate with other devices. For example, some or all of the circuit breakers 110 and 112a-n may be configured to communicate with a computing system or network 120, such as a distributed computing system, a data cloud, an “as-a-Service” (XaaS) system, data storage, data center, one or more servers, and/or the like.

In various embodiments, a computing device 125 may be configured to communicate with the circuit breakers 110 and 112a-n and/or computer system or network 120. Non-limiting examples of the computing device 125 may be a user computing device, smartphone, tablet computing device, workstation, PC, laptop, server, and/or the like. The computing device 125 may communicate with the circuit breakers 110 and 112a-n and/or computer system or network 120 via an application, such as a mobile application (or “app”). A non-limiting example of an application or mobile app may be the Brightlayer application provided by Eaton Corporation PLC.

Connecting a personal computing device 125 to the power management system 100 enables, among other things, a user of the power management system 100 to receive information about the performance of the system 100, control devices of the system 100 (e.g., opening/closing circuit breakers), and to provide input to the system 100. However, it is not required to connect a personal computing device 125 to the power management system 100, as each of the circuit breakers 110 and 112a-n can be configured to provide performance information to the user and to enable the user to provide input to the power management system 100.

For example, one or more of the circuit breakers 110 and 112a-n may include a controller 116 configured to collect power data (for instance, voltage, current, and/or the like) about any power supply or load connected tp the respective circuit breaker 110 or 112a-n, such as the power supply connected to the main circuit breaker 110 or the load(s) connected a given one of the branch circuit breakers 112a-n. In some embodiments, one or more of branch circuit breakers 112a-n may include a controller the same or similar to the controller 116. In various embodiments, one or more of circuit breakers 110 and 112a-n may be configured to perform various functions including, without limitation, web searching, automated web searching, web crawling, electronic communications (for instance, email, SMS messages, app-based messages, and/or the like).

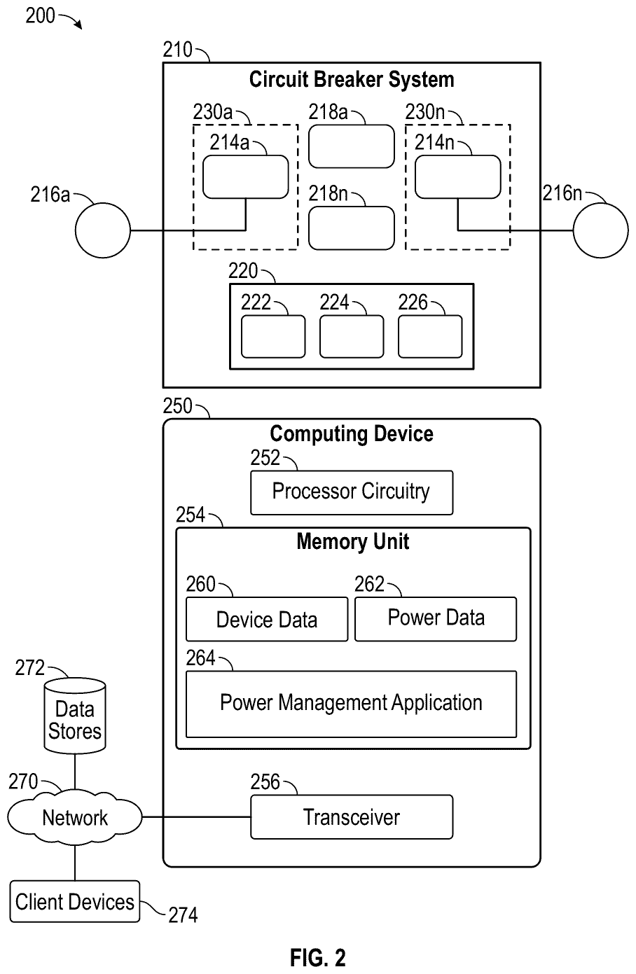

FIG. 2 illustrates an example of an operating environment 200 that may be representative of some embodiments. As shown in FIG. 2, operating environment 200 may include a circuit breaker system 210 having one or more circuit breakers 214a-n. In some embodiments, the circuit breakers 214a-n may be or may be a part of a branch circuit breaker or panel 230a-n. In various embodiments, the circuit breaker system 210, the circuit breakers 214a-n, and/or the branch circuit breakers 230a-n may be or may include a smart circuit breaker or smart circuit breaker technologies. In some embodiments, the circuit breaker system 210 may be a main electrical panel housing one or more of the circuit breakers 214a-n. In various embodiments, the circuit breaker system 210 may be a main electrical panel electrically coupled to the branch circuit breakers 230a-n (for instance, the branch circuit breakers 230a-n may be located external to the main panel of the circuit breaker system 210).

One or more of the circuit breakers 214a-n may be electrically coupled to one or more devices 216a-n. In general, a device 216a-n may include an electrical device plugged into an electrical outlet electrically coupled to (and, therefore, protected by) a respective circuit breaker 214a-n. Non-limiting examples of devices 216a-n may include appliances, electrical devices, charging devices or stations, manufacturing equipment, computers, televisions, lights, fans, and/or the like. The circuit breakers 214a-n, for example, via the sensors 218a-n, may be configured to monitor, measure, collect, or otherwise process power usage data from connected devices 216a-n.

In some embodiments, the circuit breaker system 210 may include or may be communicatively coupled with one or more sensors 218a-n. The sensors 218a-n may be configured to sense various operational conditions of the circuit breakers 214a-n and/or electrical devices electrically coupled to the circuit breakers 214a-n. For example, the sensors 218a-n may be or may include voltage sensors, current sensors, and/or the like.

In some embodiments, the circuit breaker system 210 may include one or more control units 220. The control unit 220 may include a processor (or processing circuitry, a microcontroller, a controller, and/or the like) 122, memory 124, and/or a transceiver 126 (for instance, for wired or wireless communication). In various embodiments, the circuit breaker system 210 may include one central control unit 220 providing control, processing, memory, and/or the like for the circuit breaker system 210. In other embodiments, each of the circuit breakers 214a-n may include a control unit 220. In some embodiments, the control unit 220 may be communicatively coupled to the sensors 218a-n and/or the circuit breakers 214a-n to obtain operational data from the sensors 218a-n and/or the circuit breakers 214a-n, such as voltage data, current data, and/or the like. In various embodiments, the control unit 220 may be communicatively coupled to the circuit breakers 214a-n to control various operational aspects thereof, such as opening/closing of the circuit breakers 214a-n.

In some embodiments, a computing device 250 may be communicatively coupled to the circuit breaker system 210. In various embodiments, the control unit 220 (or one of the control units 220 in an embodiment with multiple control units 220) may be, may be the same as, or may be substantially the same as the computing device 250. For instance, the control unit 220 may include some or all of the functions and components of the computing device 250. In some embodiments, the circuit breaker system 210 may include the computing device 250 as an embedded control system (e.g., as the embedded control unit 220). In some embodiments, the computing device 250 may be a remote server computer or other type of computing device.

Although only one computing device 250 is depicted in FIG. 2, embodiments are not so limited. In various embodiments, the functions, operations, configurations, data storage functions, applications, logic, and/or the like described with respect to computing device 250 may be performed by and/or stored in one or more other computing devices, for example, coupled to computing device 250 via network 270 (for instance, one or more of client devices 274). A single computing device 250 is depicted for illustrative purposes only to simplify the figure. Embodiments are not limited in this context.

Computing device 250 may include a processor circuitry 252 that may include and/or may access various logics for performing processes according to some embodiments. Processing circuitry 252 and/or portions thereof may be implemented in hardware, software, or a combination thereof. For example, a logic, circuitry, or a module may be and/or may include, but are not limited to, a process running on a processor, a processor, a hard disk drive, multiple storage drives (of optical and/or magnetic storage medium), an object, an executable, a thread of execution, a program, a computer, hardware circuitry, integrated circuits, a system-on-a-chip (SoC), memory units, logic gates, registers, semiconductor device, chips, microchips, chip sets, software components, programs, applications, firmware, software modules, computer code, a control loop, a computational model or application, an AI and/or ML model or application, variations thereof, combinations of any of the foregoing, and/or the like.

Memory unit 254 may include various types of computer-readable storage media and/or systems in the form of one or more memory units and/or storage media. In various embodiments, memory unit 254 may store various types of information and/or applications for a ghost power management system according to some embodiments. For example, memory unit 254 may store device data 260, power data 262, and/or a power management application 264. In some embodiments, some or all of device data 260, power data 262, and/or a power management application 264 may be stored in one or more data stores 272 accessible to computing device 250 via network 270. For example, one or more of data stores 272 may be or may include historical sensor data, a proprietary database, manufacturer information, device operating information, device operating current information, websites, website information, and/or the like.

Device data 260 may include information associated with the devices 216a-n. Non-limiting examples of device data 260 may include a device name, a serial number, a model identifier, and electrical usage information. The electrical usage information may include any information associated with the energy consumption of a device including ghost power consumption and energy consumption when active (for instance, when not operating in standby mode, ghost power mode, powered off, and/or the like), including, without limitation, operating current, amperage, wattage, and/or the like. As described in the present disclosure, the device data 260 may be entered manually and/or obtained automatically via the computing device 250 based on certain information, such as an image, device description, model number, and/or the like.

Power data 262 may include data associated with power usage of the devices 216a-n electrically coupled to the circuit breakers 214a-n. For example, the power data 262 may include current data, amperage data, wattage data, and/or the like. In various embodiments, the power data 262 may include power cost information, such as kilowatt-hour (kWh) information, cost per kWh, temporal electricity consumption costs, electricity costs for individual devices 216a-n, and/or the like.

The power management application 264 may be configured to perform operational aspects of the ghost power management system 200 according to various embodiments. The power management application 264 may perform software functions by being executed via processer circuitry 252. For example, the power management application 264 may receive, process, and/or store device data 260 and/or power data 262. In various embodiments, the power management application 264 may operate to provide a user interface (alone or in combination with the client devices 274). For example, the power management application 264 may provide device status information, device power usage information, device electricity cost information, device ghost power information, warnings, alerts, communications, and/or the like to the client devices 274. In various embodiments, the client devices 274 may be or may include embedded computer systems (for instance, an embedded display and/or input devices), a mobile computing device (for instance, a mobile phone, a tablet computing device, a laptop computing device, and/or the like), a workstation, a PC, a server, and/or the like. Accordingly, a user may receive status information, alerts, electricity costs, electricity cost projections, instructions, and/or the like from the power management application 264.

In various embodiments, the data generated by the sensors 218a-n may be processed by the control unit 220 for transmission by the circuit breaker system 210 using packets, streams, or other electronic communication units. In some embodiments, the data generated by the sensors 218a-n may be transmitted in a format that may include a header with identifying information, such as information identifying the circuit breaker, circuit breaker type, device, device type, and/or the like. For example, the header may indicate that the associated data is from circuit breaker 214a, or from device 216a, and/or the like. The data generated by the sensors 218a-n may be transmitted in a format that may have specific fields for the transmitted data, such as a current usage field, an amperage usage field, a ghost power indicator (for instance, a ghost power yes/no bit, symbol, value, and/or the like), an electricity cost field (for instance, kWh price from an electricity provider during the time of the power consumption), and/or the like. The power management application 264 may be configured to receive the data packet, data stream, and/or the like in the specific format to correctly parse the information from the circuit breaker system 210 for processing according to some embodiments described in the present disclosure. In this manner, the system 100 may be configured to efficiently manage the data generated by the circuit breaker system 210 using the limited resources, processing power, and memory capacity of embedded systems.

Included herein are one or more logic flows and/or method flows representative of exemplary methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, hardware, or any combination thereof. A method flow may be implemented via user activity alone or in combination with software and firmware embodiments. A logic flow and computer-implemented steps of a method flow may be implemented by computer executable instructions stored on a non-transitory computer readable medium or machine readable medium. The embodiments are not limited in this context.

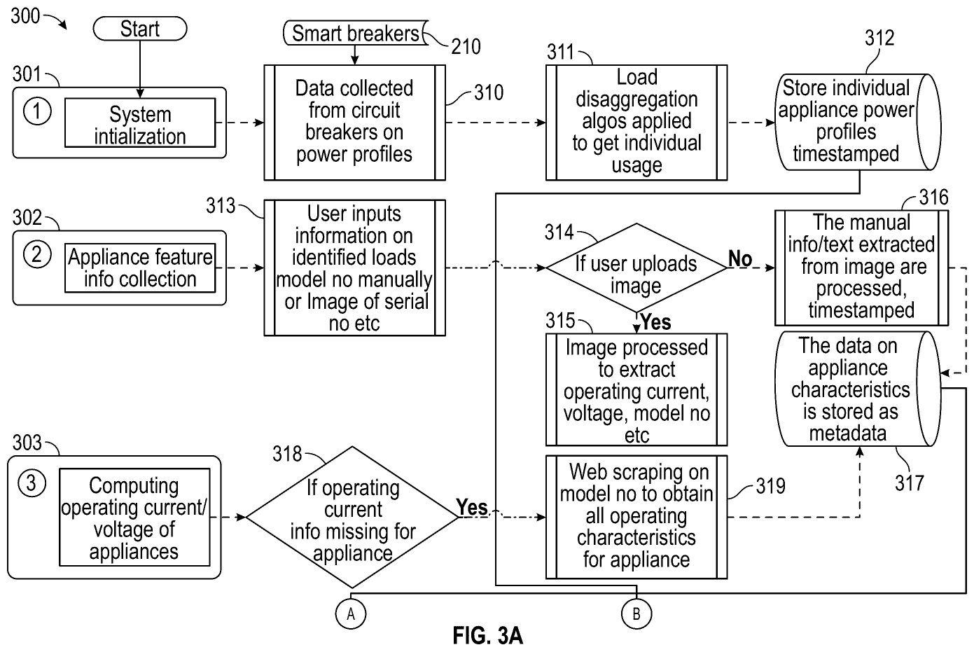

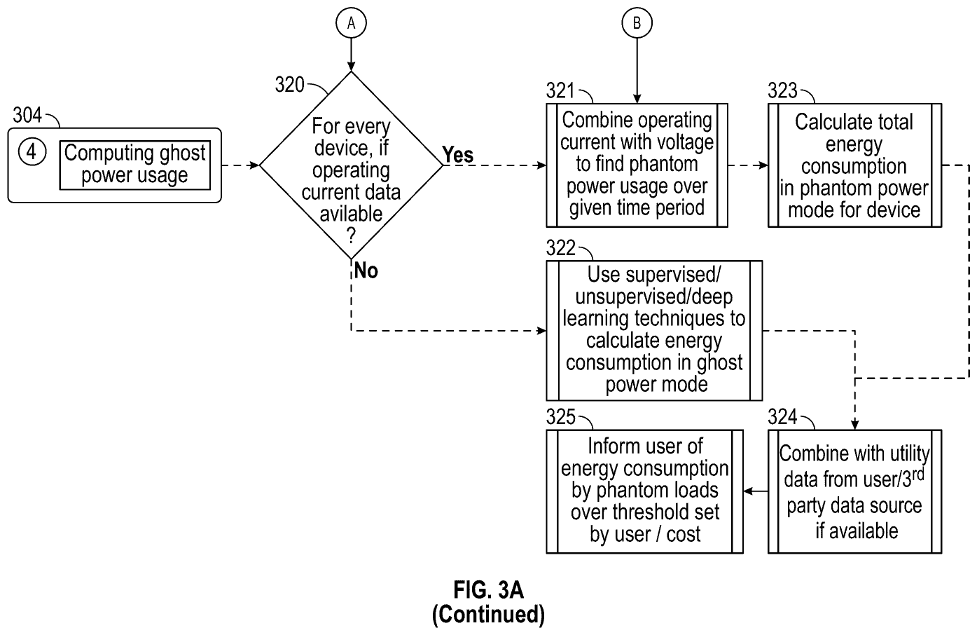

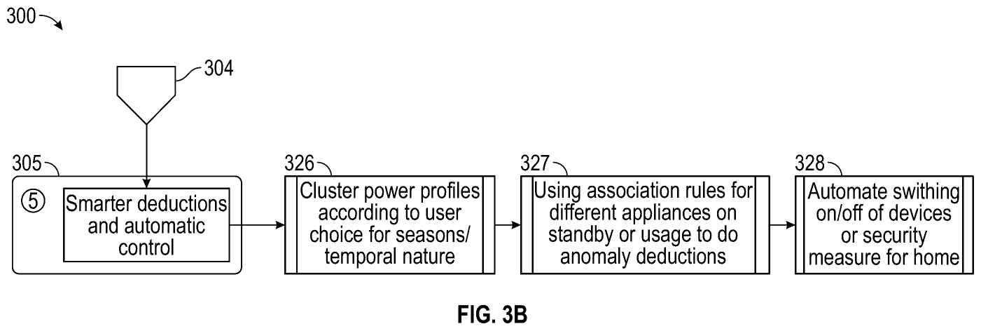

FIGS. 3A and 3B illustrate an embodiment of a method flow 300. The method flow 300 may be representative of some or all of the operations executed by one or more embodiments described herein, such as system 100 or 200. In some embodiments, the method flow 300 may be representative of some or all of the operations of a ghost power management method according to the present disclosure. For example, the method flow 300 may be representative of some or all of the operations of a method for monitoring and actively managing ghost power usage and phantom load consumption in accordance with an exemplary embodiment of the disclosed concept.

In various embodiments, the method flow 300 can be implemented in any setting that uses circuit breakers (smart circuit breakers, in particular) to manage electrical loads. The method flow 300 can be implemented by a number of devices, such as one or more smart circuit breakers or a mobile phone app, for example and without limitation.

The method flow 300 may include process 301 for System Initialization. During process 301, primary or raw data is collected from the smart circuit breakers 210 in real-time at step 310. In some embodiments, raw data may include measurements of current, voltage, and energy values consumed on a circuit breaker. The raw data may be processed, for instance, including the addition of timestamps or other metadata. If the appliance is on a single load circuit breaker, no further computations or processing may be required. For multi-load circuit breakers, step 311 may be performed for load disaggregation to disaggregate the raw power data into individual appliances and their usages. For example, disaggregation may be performed via algorithms using signal processing or deep learning methods. The data generated via steps 310 and/or 311 may be stored in one or more data storages at step 312. Although the method flow 300 is described with respect to appliances, embodiments are not so limited, as the method flow 300 may be performed for other types of electrical devices.

Process 302 of the method flow 300 may include appliance feature information collection. At step 313, appliance information may be collected. For example, based on the loads identified in a given environment, user feedback regarding load names/types, model number, device description, manufacturer information, and/or the like may be collected. In some embodiments, the device information may be input via an application the same or similar to the power management application 264 being executed on a client device 274, circuit system 210, and/or a computing device 250. In some embodiments, the appliance information can be provided by manual input or by uploading an image (step 314) showing the serial number or model number on the appliance. If an image is uploaded by user, further image processing takes place to extract the operating current, operating voltage, model number, and/or the like (step 315) from the image alone or in combination with other information, such as a key, device identifier, and/or the like. and stored as metadata. At step 316, a user may enter some or all of the appliance information (regardless of whether an image is uploaded). The appliance information may be stored in a data storage at step 312.

Process 303 of the method flow 300 includes an operating current calculation. If the operating current information is missing or cannot be extracted from a user-uploaded image at step 318, internet searching, web scraping, and/or the like may be performed using search parameters such as model number, serial number, or any other unique identifier to determine operating current information at block 319. In some embodiments, the searching performed at block 319 may be performed regardless of whether an image is uploaded, in addition to the image-based information, and/or the like.

The operating current information may include the operating current of an appliance or other device when active in use during one or more operational modes. For example, for a television, the operating current may be the operating current when the television is powered on. In another example, for a charging device, the operating current may be the operating current when the charging device is connected to an powering a device (including a low-level or “trickle” charge when the device being charged is connected but at a full or 100% charge).

In various embodiments, the ghost power may be determined as being a power consumption level (current, wattage, amperage, and/or the like depending on the measurement category), a threshold level, or amount below the operating current. Different devices may have different ghost power thresholds. For example, power consumption by a device may be designated as ghost power if the power consumption is a threshold percentage below the operating current. In another example, power consumption by a device may be designated as ghost power if the power consumption is a threshold amount below the operating current. In an additional example, power consumption by a device may be designated as ghost power if the power consumption is at or below a minimal threshold amount.

For instance, for a first device, ghost power may be designated as current that is equal to or less than (operating current)×(threshold percentage/100). Accordingly, if the first device has an operating current of 10 Amps and a threshold percentage of 50%, then ghost power consumption is power consumption of the device at (10 Amps)×(50/100)=5 Amps (or below). In some embodiments, the ghost power threshold may be a value threshold. For example, for a second device, the operating current may be 10 Amps and the ghost power threshold may be 2 Amps such that power draw by the second device equal to or less than 2 Amps may be designated as ghost power consumption. For example, for a third device, the operating current may be 10 Amps and the ghost power threshold may equal (operating current−threshold amount), such as 10 Amps−5 Amps, such that power draw by the second device equal to or less than 5 Amps may be designated as ghost power consumption. In various embodiments, the threshold value and/or percentage may be based on machine learning techniques, manufacturer information, internet research or web crawling, historical data, and/or the like.

In some embodiments, the smart circuit breaker may include an application interface (for instance, the power management application 264, the control unit 220, and/or the like). The application interface may graphically present devices connected to the circuit breaker that are plugged in and powered on (either active or in ghost power mode). The application interface may provide a ghost or standby mode selection mechanism (e.g., a check box, text box, radio button, and/or the like) that allows a user to designate which devices are currently in ghost power mode. The application may capture the operating power information (current, voltage, and/or the like) for the devices designated as being in ghost or standby mode as a snapshot and/or over a period of time to learn the power information (current, voltage, and/or the like) of each device in ghost or standby mode.

For example, via the application interface, a user may select a device that is plugged in and powered off (e.g., a television) or that is plugged in but inactive (e.g., a microwave oven). The user may indicate via selection of a graphical ghost or standby mode object that the device is in ghost or standby mode. The application may capture the power information (e.g., current) as ghost power information. The ghost power information may be compared with the stored operating current of the third device. The ghost power information may be used to automatically generate a ghost power threshold by the application (for instance, the power management application 264, the control unit 220, and/or the like). For instance, the captured power information may be used to generate a percentage threshold or an amount-based threshold. For example, if a device with an operating current of 10 Amps is designated as being in ghost power mode and the captured power information indicates that the device is currently drawing 2 Amps, a ghost power threshold may be determined by the power management application 264 as being 20% of operating current or a current draw of 2 Amps or less.

In some embodiments, based on usage history of an appliance, the application (for instance, the power management application 264, the control unit 220, and/or the like) calculates the levels of power usage and calculates power by comparing these levels to the standard operating power of the appliance. Algorithms, machine learning models, and/or other computer-based processes can be used to analyze the usage pattern and predict the standby power.

For example, the application can monitor power usage over a duration and predict the ghost power threshold as the amount of steady power (for instance, within a threshold volatility range) prior to a power spike (for instance, increase in current consumption when powering on or activating a device). For instance, if a device has a draw of 1 Amp of current over a duration of 12 hours, with a spike to 10 Amps that is maintained for 2 hours, followed by a drop back down to 1 Amp, the application may determine that the 10 Amp spike occurred during device use and the preceding and following 1 Amp current draws were ghost power consumption. The 1 Amp current draw may be used to define a ghost power threshold and/or provided in a ghost power profile for the device according to various embodiments.

Process 304 of the method flow 300 is computing ghost power usage. Ghost power usage can be calculated using one or more various methods. For example, process 304 may determine whether operating current data is available at step 304. Certain devices may have stored operating current and ghost power current data available. In some embodiments, process 304 may include combining operating current with voltage to find phantom power usage over a given time period at step 321. In deep learning techniques at step 322, LSTMs (Long Short-Term Memory) can be used to learn the sequential data by considering the device's power profile and current consumption over time. At step 323, the process 304 may include calculating the total energy consumption in ghost power mode for a device. Steps 321-323 may include or may use various statistical methods which determine the mean-median and other statistics when the device is on and applies thresholds for identification of when power dips below the threshold. This threshold should be lower than the operating current found in the method flow 300. For instance, the ghost power can also be computed using unsupervised techniques including, without limitation, data clustering, averaging, DBSCAN (Density-Based Spatial Clustering of Applications with Noise), K-means (K-means clustering) to cluster power profiles.

In some embodiments, the ghost power information determined via steps 321-233 may be combined with utility data, third-party data, public information, and/or the like to determine, validate, or otherwise augment the determined ghost power information. Once determined, the ghost power mode threshold is stored for the device on a storage device, server, cloud service, and/or the like in order to be applied to new data.

At block 325, the ghost power threshold and/or ghost power usage can be applied to calculate the energy consumption and costs associated thereof. The costs may be determined based on energy price estimates, utility data (for instance, sourced from a third party or from the user directly if the user shares their costs associated for energy use) to inform the power consumption from ghost power loads. In some embodiments, the ghost power associated costs may be determined in specific durations of time, time periods (e.g., night, day, weekdays, weekends, and/or the like), and/or the like.

Referring to FIG. 3B, process 305 of the method flow 300 includes steps for smarter deductions and automatic control. The method flow 300 may cluster all of the appliances on ghost power at the different temporal zone of usage at step 326, for instance, according to user settings, default settings, and/or the like. In some embodiments, the temporal zones can be specific time zones of a day (for instance, morning, afternoon, night, and/or the like), types of day (for instance, weekday, weekend, work-from-home day, in-office day, holiday, and/or the like), seasons of the year, and/or the like. In various embodiments, at step 327, the clusters can be used to automate the switching on/off of a specific zone or device cluster/group of the house where equipment is not being used. In some embodiments, the clusters can be used for security measures in a structure, where alerts could be sent when a specific appliance is being used and others are on standby for a long time. In addition, associations can be built of different appliances on standby or in usage to flag the anomaly in the usage of appliances. Based on the past associations, rules can be established regarding which equipment is mostly being used or is on standby with others. These will help to flag/alert the users for anomalous usage or mimic a relatively lower energy consuming behavior for safety purposes when the structure is vacant or otherwise at a lower level of use. At step 328, the method flow 300 may operate to automatically switch on/off circuit breakers or devices for security or safety measures of a structure, such as a residential home.

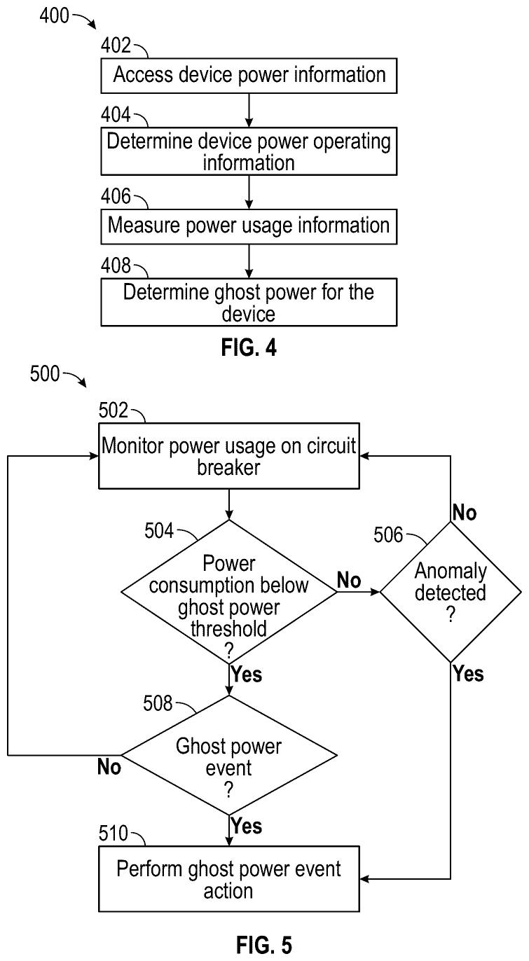

FIG. 4 illustrates an embodiment of a logic flow 400. The logic flow 400 may be representative of some or all of the operations executed by one or more embodiments described herein, such as system 100, system 200, circuit breaker 110, circuit breaker 210, and/or computing device 250. In some embodiments, the logic flow 400 may be representative of some or all of the operations of determining ghost power for a device.

In some embodiments, the logic flow (or process) 400 may include accessing device power information at block 402. For example, the control unit 220 (for instance, operating as a control unit or as the computing device 250 of the circuit breaker system 210) may access device power information of devices electrically coupled to the circuit breaker system 210. For instance, the control unit 220 may be configured to automatically detect devices coupled to the circuit breaker system 210 through electrical or wireless signals, messages, and/or the like. In various embodiments, at least a portion of the device power information may be entered via a user, such as through an application interface of a client device 184. The device power information may include information that may be used to determine operating power information, such as operating currents, voltages, power, and/or the like. In various embodiments, the device power information may include product names, manufacturer information, serial numbers, model numbers, product identifiers, images, and/or the like.

At block 404, the logic flow 400 may determine device power operating information. For example, the control unit 220 may use the power information provided at block 404 to determine the power operating information for one or more connected devices. For example, the power management application 264 may determine the operating current of a device 216a based on user-provided information, manufacturer information, and/or the like. In some embodiments, the power management application 264 may perform a search of available information via the internet, databases, proprietary databases, local databases and/or memory, and/or the like to determine power operating information for one or more devices 216a-n. In various embodiments, the power management application 264 may learn the operating current through monitoring current usage of the device (e.g., a device has a current spike from 1 Amp up to 10 Amps that is maintained for a duration and then falls again to 1 Amp, indicating that 1 Amp is the ghost power usage and 10 Amps is the operating current).

In various embodiments, the power operating information may include power information for a device when it is plugged in, powered on, and active in one or more operating modes. The power operating information may include an operating current, an operating voltage, and/or the like. For example, the power operating information may be the operating current of a television when powered on and displaying content. In another example, the power operating information may be the operating current of a microwave oven when active in a cooking mode. The power management application 264 may generate and/or access various power profiles for different connected devices.

The power profiles may include operating ranges (for instance, operating current ranges for active devices), temporal information, and/or the like. In some embodiments, a power profile may include a device grouping. For example, a group of appliances in a kitchen may be grouped together due to being commonly used at the same time (for instance, from 4:00 pm to 6:00 pm on weekdays) or being in the same room. In another example, a group of laptop chargers for an office space may be active from 8:00 am until 5:00 pm and in standby mode from 5:00 pm until 8:00 am. In this manner, devices may be grouped according to expected usage times, regions, etc. in order to evaluate ghost power usage.

The logic flow 400 may include measuring power usage information at block 406. For example, the circuit breaker system 210 may, via sensors 218a-n, measure current, voltage, and/or other power usage information of the devices 216a-n electrically coupled to the circuit breaker 210. The power usage information may be provided to the power management application 264 (for instance, via the control unit 210 and/or the computing device 250).

At block 408, the logic flow 400 may determine ghost power for a device. For example, the power management application 264 may compare the current power usage to the operating power information to determine whether a device is in ghost power mode. In some embodiments, ghost power mode may be determined based on a ghost power profile and/or one or more ghost power mode thresholds, such as an operating current a threshold percentage below the operating current, or a ghost power mode operating value indicating a threshold current for ghost power mode (for instance, Device A is designated as operating in ghost power mode if the device is operating at or below 2 Amps).

In some embodiments, ghost power mode information may be stored for a device responsive to detection of a ghost power mode state. The ghost power mode information may include the power operating information (for instance, ghost power mode operating current), ghost power mode time and/or day information, ghost power mode duration, other devices in ghost power mode, and/or the like. In some embodiments, a ghost power mode profile may be built for each device to learn and store typical ghost power mode patterns for a device. In various embodiments, devices may be indicated as being grouped into ghost power mode groups of devices that are in ghost power mode at similar times, locations, durations, and/or the like.

FIG. 5 illustrates an embodiment of a logic flow 500. The logic flow 500 may be representative of some or all of the operations executed by one or more embodiments described herein, such as system 100, system 200, circuit breaker 110, circuit breaker 210, and/or computing device 250. In some embodiments, the logic flow 500 may be representative of some or all of the operations of managing a ghost power event.

In some embodiments, the logic flow (or process) 500 may include monitoring power usage on a circuit breaker at block 502. For example, the circuit breaker system 210 may, via sensors 218a-n, measure current, voltage, and/or other power usage information of the devices 216a-n electrically coupled to the circuit breaker 210. The power usage information may be provided to the power management application 264 (for instance, via the control unit 210 and/or the computing device 250). The power management application 264 may compare the monitored power usage information to power profiles, ghost power profiles, operating information, and/or the like for devices saved in the device data 260 and corresponding power data 262.

At block 504, the logic flow 500 determines whether power consumption for a device is below a ghost power threshold. For example, the control unit 220 (for instance, operating as a control unit or as the computing device 250 of the circuit breaker system 210) may determine that Device B is operating at 2 Amps, which has a normal operating current of 10 Amps and a ghost power threshold of 3 Amps (for instance, the ghost power profile for Device B indicates that the device is in ghost or standby mode when the current draw is at or below 3 Amps).

At block 508, the logic flow 500 may determine whether a ghost power event has been triggered due to the detection of a device operating at a ghost power threshold at block 504. A ghost power event includes an action, event, and/or the like that is performed by the circuit breaker system 210 responsive to the detection of a device being in ghost power mode alone or in combination with other ghost power information. Non-limiting examples of ghost power information may include a duration of a device being in ghost power mode, time of day information, other devices in ghost power mode, and/or the like.

Ghost power events may include, without limitation, sending alerts to client devices, opening/closing circuit breakers, providing user instructions, tracking ghost power energy costs, and/or the like.

For example, the circuit breaker system 210 may be configured to close a circuit breaker during a certain duration (e.g., from 12:00 am to 5:00 am) if all devices 216a-n on the circuit breaker 214a-n are in ghost power mode (and to close the circuit after the duration). In another example, the circuit breaker system 210 may be configured to send a message to a user to confirm the closing of the circuit breaker 214a-n responsive to all of the devices 216a-n on the circuit breaker 214a-n being in ghost power mode. In some embodiments, if a circuit breaker 214a-n is closed due to a ghost power event the circuit breaker system 210 may be configured to open (or re-open) the circuit breaker 214a-n at a specific time (for instance, at 5:00 am) or in response to user instructions. The ghost power events and default actions associated therewith may be stored via the power management application 164.

In another example, when a device is determined to be in ghost power mode, the power management application 164 may begin tracking ghost energy costs. For example, using utility energy cost information (actual and/or estimated), the power management application 164 may begin to calculate and store the energy costs for the device when operating in ghost power mode. For example, by calculating energy consumption rates (current, voltage, kWh, and/or the like) per unit cost, the cost for powering the device during ghost power mode may be determined. The ghost power mode energy costs may be determined per device, per day, per ghost power mode duration, per group (e.g., kitchen group, office group, and/or the like), per month, per year, and/or the like.

The logic flow 500 may determine whether an anomaly has been detected responsive to a determination that a monitored device is not operating below the ghost power threshold at block 506. For example, the power management application 164 may use the power profiles and/or ghost power profiles to determine expected power usage. If a device is not in ghost power mode during an expected ghost power duration, this condition may signal an anomaly, such as a security situation (unauthorized access to a location), safety hazard (unsafe electrical condition), and/or the like. For example, the logic flow 500 may determine that an oven appliance is not in ghost power mode at 3:00 am when the device is expected to be in ghost power mode according to the ghost profile of the device. The unexpected operating current may indicate a hazardous electrical condition for the oven appliance. Accordingly, the power management application 264 may cause a ghost power event action of generating an alert to a client device 284 and/or closing the circuit breaker 214a-n electrically coupled to the oven appliance.

At block 510, the logic flow 500 may perform a ghost power event action based on the determinations at block 506 and/or 508.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A computer-implemented method, comprising, via at least one processing circuitry operatively coupled to a smart circuit breaker:
monitoring power usage of a device detected by the smart circuit breaker to be electrically coupled to a circuit breaker of the smart circuit breaker;
accessing a ghost power profile of the device, the ghost power profile comprising ghost power information including a ghost power threshold indicating that the device is operating in ghost power mode;
determining that the device is operating in the ghost power mode based on a comparison of the power usage with the ghost power threshold; and
performing a ghost power event responsive to determining that the device is operating in the ghost power mode.

2. The computer-implemented method of claim 1, wherein the ghost power event comprises closing the circuit breaker.

3. The computer-implemented method of claim 1, wherein the ghost power event comprises determining a cost of operating the device in the ghost power mode.

4. The computer-implemented method of claim 1, further comprising:
receiving device information of the device via a power management application interface;
determining an operating current for the device based on the device information; and
determining the ghost power threshold as at least one of a value or percentage below the operating current.

5. The computer-implemented method of claim 4, wherein the device information comprises an image and the operating current is determined based on at least one of an automated internet search or a web-crawling process.

6. The computer implemented method of claim 1, further comprising determining the ghost power threshold based on an operating current of the device, wherein the ghost power threshold comprises one of a percentage of the operating current or a value below the operating current.

7. The computer implemented method of claim 1, further comprising providing a user interface to graphically designate that the device is operating in the ghost power mode.

8. The computer implemented method of claim 1, further comprising determining that the device is not operating in the ghost power mode based on the comparison of the power usage with the ghost power threshold responsive to a current of the device being greater than the ghost power threshold.

9. The computer implemented method of claim 8, further comprising determining whether an anomaly is present responsive to the device not operating below the ghost power threshold based on the ghost power profile indicating that the device is expected to be operating in the ghost power mode.

10. The computer implemented method of claim 9, further comprising closing the circuit breaker responsive to detecting the anomaly.

11. A smart circuit breaker panel, comprising:
a plurality of smart circuit breakers;
a plurality of sensors configured to monitor power usage of devices electrically coupled to the plurality of smart circuit breakers; and
an embedded control unit operably coupled to the plurality of smart circuit breakers, comprising a memory coupled to a processing circuitry, the memory comprising instructions that, when executed by the processing circuitry, cause the at least one processing circuitry to:
monitor power usage of the devices measured by the plurality of sensors;
access at least one ghost power profile associated with at least one of the devices, the at least one ghost power profile comprising ghost power information including a ghost power threshold indicating that the at least one of the devices is operating in ghost power mode;
determine that the device is operating in the ghost power mode based on a comparison of the power usage with the ghost power threshold; and
perform a ghost power event responsive to determining that the device is operating in the ghost power mode.

12. The smart circuit breaker panel of claim 11, wherein the ghost power event comprises closing the circuit breaker.

13. The smart circuit breaker panel of claim 11, wherein the ghost power event comprises determining a cost of operating the device in the ghost power mode.

14. The smart circuit breaker panel of claim 11, the instructions, when executed by the processing circuitry, to cause the at least one processing circuitry to:
receive device information of the device via a power management application interface;
determine an operating current for the device based on the device information; and
determine the ghost power threshold as at least one of a value or percentage below the operating current.

15. The smart circuit breaker panel of claim 14, wherein the device information comprises an image and the operating current is determined based on at least one of an automated internet search or a web-crawling process.

16. The smart circuit breaker panel of claim 11, the instructions, when executed by the processing circuitry, to cause the at least one processing circuitry to determine the ghost power threshold based on an operating current of the device, wherein the ghost power threshold comprises one of a percentage of the operating current or a value below the operating current.

17. The smart circuit breaker panel of claim 11, the instructions, when executed by the processing circuitry, to cause the at least one processing circuitry to provide a user interface to graphically designate that the device is operating in the ghost power mode.

18. A computer-implemented method, comprising, via at least one processing circuitry operably coupled to a smart circuit breaker system:
accessing device information of at least one device electrically coupled to a circuit breaker of the smart circuit breaker system, the device information comprising at least one of an image, a device identifier, a serial number, or a model number;
determine operating current information for the device based on the device information;
measure power usage information of the device via at least one sensor operably coupled to the circuit breaker; and
determine a ghost power threshold for the device based on the operating current information and the power usage information, the ghost power threshold comprising a current usage value indicating that the device is in a ghost power mode.

19. The computer-implemented method of claim 18, further comprising:
determining that the device is operating in the ghost power mode based on a comparison of power usage of the device with the ghost power threshold; and
performing a ghost power event responsive to determining that the device is operating in the ghost power mode.

20. The computer-implemented method of claim 18, wherein the ghost power event comprises closing the circuit breaker responsive to a plurality of devices associated with the circuit breaker operating in the ghost power mode.
